(19) United States
(12) Patent Application Publication
(10) Pub. No.: US 2018/0151294 A1
(43) Pub. Date: May 31, 2018

(54) METHOD OF PRODUCING SOFT MAGNETIC POWDER

(71) Applicants: Hyundai Motor Company, Seoul (KR); Kia Motors Corporation, Seoul (KR); Industry-University Cooperation Foundation Hanyang University ERICA Campus, Ansan-si (KR)

(72) Inventors: Young Min Kim, lncheon (KR); Shin Gyu KIM, Hwaseong-si (KR); Jong Ryoul KIM, Seoul (KR); Moo Sung CHOI, Miryang-si (KR); Sueng Chuel CHO, Seoul (KR); Seung Jae JEONG, Busan (KR); Sung Hoon LEE, Goyang-si (KR); Yong Ho CHOA, Ansan-si (KR)

(73) Assignees: Hyundai Motor Company, Seoul (KR); Kia Motors Corporation, Seoul (KR); Industry-University Cooperation Foundation Hanyang University ERICA Campus, Ansan-si (KR)

(21) Appl. No.: 15/653,352

(22) Filed: Jul. 18, 2017

(30) Foreign Application Priority Data
Nov. 29, 2016 (KR) 10-2016-0160135

(51) Int. Cl. H01F 41/02; H01F 1/20

(52) U.S. Cl. CPC H01F 41/0246; B22F 2003/248; C22C 2202/02; H01F 1/20

(57) ABSTRACT

Disclosed is a method of producing a soft magnetic powder including spraying gas or water into a pure iron bath to prepare a pure iron powder, surface-treating the pure iron powder by milling to increase surface stress of the pure iron powder and make the pure iron powder spherical, and subjecting the surface-treated pure iron powder to reducing thermal treatment to grow surface crystal grains of the pure iron powder and to prepare a soft magnetic powder.

### CROSS-REFERENCE(S) TO RELATED APPLICATIONS

The present application claims priority to Korean Patent Application No. 10-2016-0160135, filed on Nov. 29, 2016, the entire contents of which is incorporated herein for all purposes by this reference.

### BACKGROUND OF THE INVENTION

### Field of the Invention

The present invention relates to a method of producing a soft magnetic powder and more particularly, to a method of producing a soft magnetic powder which is cheap, exhibits excellent magnetism and entails less core loss by surface-treatment.

### Description of Related Art

In general, soft magnetic materials are commonly used in a bulk, plate, or powdery form and are utilized in applications including core materials in inductors, stators and rotors of electronic devices, actuators, sensors, and transformer cores.

In particular, a soft magnetic powder, which is sintered and molded in combination with an organic substance, is used as an electronic component, a shielding material or the like, and is used as a material for various inductors, noise filters, reactors, pulse transformers and the like depending on the magnetic characteristics of the soft powder.

Recently, in accordance with increasing demand for eco-friendly vehicles and the acceleration of vehicle digitalization, demand for magnetic powders used for vehicle powder convertors and electronic parts are gradually increasing.

Such soft magnetic powders include molypermalloy (Fe—Ni—Mo), high-flux (Fe—Ni), sendust (Fe—Si—Al), Fe—Si powders, pure iron powders and the like.

The magnetic characteristics of the soft magnetic powder can be determined by the alloy elements, impurity concentrations, the shapes and sizes of particles, phase transfer, directional properties and the like. Pure iron powder is generally used due to its lower price compared to other soft magnetic powders, but has the drawbacks of a deteriorated saturation flux density (Bs) due to relatively low molding density and increased core loss, and is disadvantageously inapplicable to parts requiring high flux density and low core loss.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

The present invention has been made in view of the above problems, and an aspect of the present invention is directed to provide a method of producing a soft magnetic powder which is cheap, exhibits excellent saturation flux density, entails less core loss, and includes pure iron.

It is another aspect of the present invention to provide a method of producing a soft magnetic powder which exhibits excellent moldability.

In accordance with the present invention, the above and other aspects can be accomplished by the provision of a method of producing a soft magnetic powder including spraying gas or water into a pure iron bath to prepare a pure iron powder, surface-treating the pure iron powder by milling to increase surface stress of the pure iron powder and spherize the pure iron powder, and subjecting the surface-treated pure iron powder to a reducing thermal treatment to grow surface crystal grains of the pure iron powder and thereby to prepare a soft magnetic powder.

The milling is preferably carried out by surface-treatment using a ball-mill and, more specifically, using a ball with a diameter of 2.5 mm to 3.5 mm in a weight ratio of ball to pure iron powder of 7:1 to 10:1 for 5 to 7 hours.

In the milling step, the surface-treated pure iron powder may have an apparent density of 3.6 g/cc or more and a flow rate of 2.8 g/s or more.

In the milling step, the surface-treated pure iron powder may have an apparent density of 3.6 g/cc or more and a flow time of 18 s/50 g or less.

The thermal treatment may be conducted at a temperature of 480° C. to 530° C. under an inert atmosphere.

The soft magnetic powder may have a saturation flux density of 1.55 T or more and a core loss of 45 W/kg or less under conditions of 400 Hz and 1.0 T.

The methods and apparatuses of the present invention have other features and advantages which will be apparent from or are set forth in more detail in the accompanying drawings, which are incorporated herein, and the following Detailed Description, which together server to explain certain principles of the present invention.

### BRIEF DESCRIPTION OF THE DRAWINGS

FIG. 1 is a flowchart illustrating a method of producing a soft magnetic powder according to an exemplary embodiment of the present invention;

FIG. 2 is a graph showing apparent density and flow time measured according to the diameter of the ball used in the milling according to an exemplary embodiment of the present invention;

FIG. 3 is a graph showing apparent density and flow time according to the weight ratio of the ball to pure iron powder during milling according to an exemplary embodiment of the present invention;

FIG. 4 is a graph showing apparent density and flow time according to milling time when ball-milling using a ball with a diameter of 3 mm at a weight ratio of the ball to pure iron powder of 8:1;

FIG. 5A and FIG. 5B are images showing a general pure iron powder and a pure iron powder surface-treated, respectively, according to an exemplary embodiment of the present invention;

FIG. 6 is a graph showing saturation flux density after molding, according to apparent density of a soft magnetic powder and flow time; and

FIG. 7A and FIG. 7B are images showing crystal grain sizes of a general pure iron powder and a soft magnetic powder prepared according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is intended to cover not only the exemplary embodiments, but also various alternatives, modifications, equivalents and other embodiments, which may be included within the spirit and scope of the invention as defined by the appended claims.

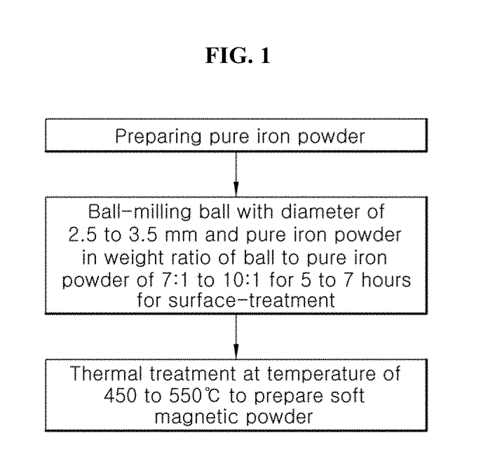

FIG. 1 is a flowchart illustrating a method of producing a soft magnetic powder according to an exemplary embodiment of the present invention.

As shown in FIG. 1, the method of producing a soft magnetic powder to an exemplary embodiment of the present invention includes preparing a pure iron powder, surface-treating the pure iron powder by milling, and subjecting the surface-treated pure iron powder to reducing thermal treatment to prepare a soft magnetic powder.

In the step of preparing a pure iron powder, high-pressure gas or water is sprayed into a pure iron bath to conduct atomizing and thereby prepare a pure iron powder.

After the pure iron powder is prepared as described above, in the step of milling, the pure iron powder is surface-treated by milling to make the powder spherical and increase surface stress. As a result, in the subsequent thermal treatment step, crystal grains grow smoothly so a soft magnetic powder with high saturation flux density and less core loss can be advantageously produced.

the milling according to an exemplary embodiment of the present invention is preferably carried out by surface-treating the pure iron powder in a ball-mill manner using a ball having a diameter of 2.5 mm to 3.5 mm.

Apparent densities and times of all powders according to an exemplary embodiment of the present invention were evaluated in accordance with ASTM B212. More specifically, a powder flows through an orifice of a standard fluidity meter (Hall flowmeter) and is fed to a cup with a volume of 25 cc, the surface of the powder is flattened out, and the powder present in the cup is weighed and determined. Flow time is defined as the time required for 50 g of a powder to pass through the orifice.

In the present case, powders having identical ingredients and weight exhibit a short flow time because the powder has a sphere-like shape and thus improved flowability.

TABLE 1

| | | | Weight | | | | |
|---|---|---|---|---|---|---|---|
| | | | ratio | | | | |
| | | Weight of | [ball:pure | | | | |
| Ball | Weight of | pure iron | iron | Milling | Milling | Apparent | Flow |
| diameter | balls | powder | powder] | rate | time | density | time |
| (mm) | (g) | (g) | (g) | (rpm) | (hr) | (g/cc) | (sec/50 g) |
| — | — | — | — | — | — | 3.1350 | 23.48 |
| 0.65 | 70 | 35 | 2 | 300 | 6 | 3.2254 | 21.44 |
| 1 | 70 | 35 | 2 | 300 | 6 | 3.3141 | 20.58 |
| 2 | 70 | 35 | 2 | 300 | 6 | 3.4947 | 19.11 |
| 3 | 70 | 35 | 2 | 300 | 6 | 3.5832 | 18.40 |
| 4 | 70 | 35 | 2 | 300 | 6 | 3.5183 | 19.01 |

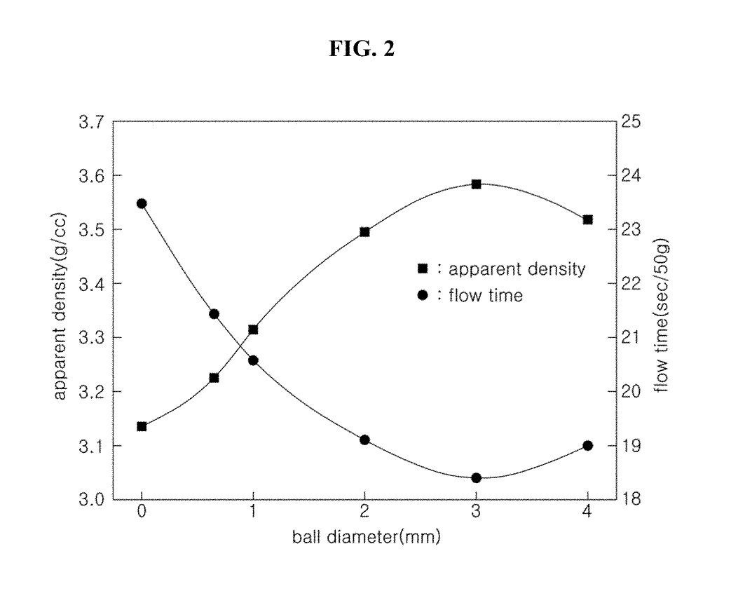

FIG. 2 is a graph showing apparent density and flow time measured according to the diameter of the ball used in the milling of the present invention.

As can be seen from Table 1 and FIG. 2, as the diameter of the ball used in the milling gradually increases, apparent density gradually increases and flow time gradually decreases. When the diameter of the ball is 3 mm, apparent density is the highest and flow time is the shortest and then as the diameter of the ball increases apparent density decreases and flow time increases again.

Accordingly, the milling according to an exemplary embodiment of the present invention is preferably carried out by ball-milling using a ball with a diameter of 2.5 mm to 3.5 mm to impart excellent apparent density and flow time to the surface-treated pure iron powder.

More preferably, the milling according to an exemplary embodiment of the present invention is carried out by milling in a weight ratio of ball to pure iron powder of 7:1 to 10:1 for 5 to 7 hours for surface-treatment.

TABLE 2

| | | | Weight | | | | |
|---|---|---|---|---|---|---|---|
| | | | ratio | | | | |
| | | Weight of | [ball:pure | | | | |
| Ball | Weight of | pure iron | iron | Milling | Milling | Apparent | Flow |
| diameter | balls | powder | powder] | rate | time | density | time |
| (mm) | (g) | (g) | (g) | (rpm) | (hr) | (g/cc) | (sec/50 g) |
| — | — | — | — | — | — | 3.1350 | 23.48 |
| 3 | 200 | 100 | 2 | 300 | 6 | 3.5832 | 18.40 |
| 3 | 400 | 100 | 4 | 300 | 6 | 3.5789 | 18.34 |
| 3 | 600 | 100 | 6 | 300 | 6 | 3.6031 | 18.03 |
| 3 | 800 | 100 | 8 | 300 | 6 | 3.6887 | 17.41 |
| 3 | 1000 | 100 | 10 | 300 | 6 | 3.6437 | 17.63 |
| 3 | 1200 | 100 | 12 | 300 | 6 | 3.4195 | 23.22 |

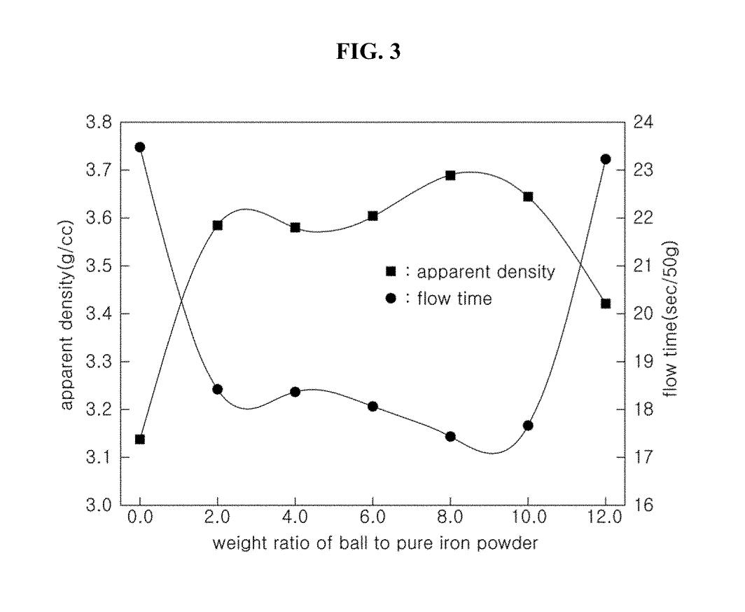

Table 2 shows apparent density and flow time according to the weight ratio of ball to pure iron powder during surface-treatment of the pure iron powder using a ball mill, and FIG. 3 is a graph showing apparent density and flow time according to the weight ratio of ball to pure iron powder during milling of the present invention.

As can be seen from Table 2 and FIG. 3, when the weight ratio of ball to pure iron powder ranges from 7 to 10, apparent density is high and flow time is short, and when the weight ratio is outside of the present range, apparent density gradually increases and flow time gradually increases.

TABLE 3

| | | | Weight | | | | |
|---|---|---|---|---|---|---|---|
| | | | ratio | | | | |
| | | Weight of | [ball:pure | | | | |
| Ball | Weight of | pure iron | iron | Milling | Milling | Apparent | Flow |
| diameter | balls | powder | powder] | rate | time | density | time |
| (mm) | (g) | (g) | (g) | (rpm) | (hr) | (g/cc) | (sec/50 g) |
| — | — | — | — | — | — | 3.1350 | 23.48 |
| 3 | 800 | 100 | 8 | 300 | 2 | 3.5588 | 18.33 |
| 3 | 800 | 100 | 8 | 300 | 4 | 3.6336 | 17.54 |
| 3 | 800 | 100 | 8 | 300 | 6 | 3.6887 | 17.41 |
| 3 | 800 | 100 | 8 | 300 | 8 | 3.6460 | 17.60 |

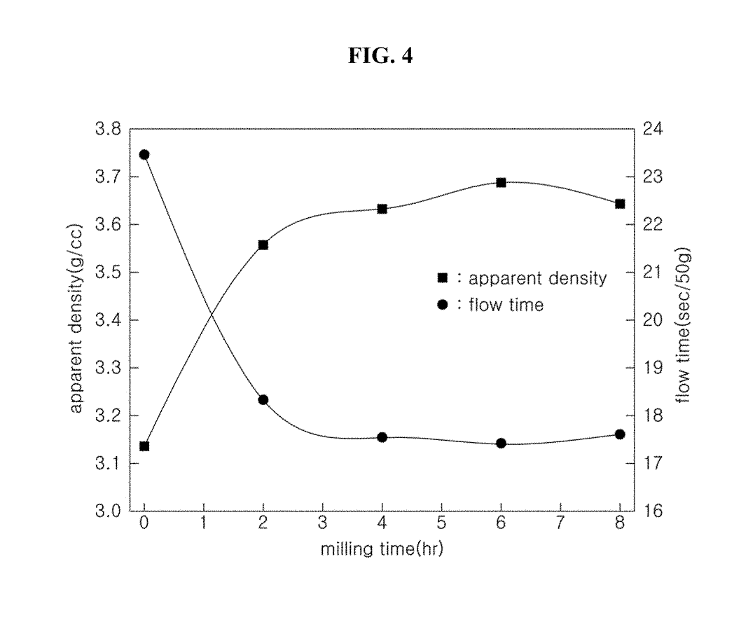

Table 3 shows apparent density and flow time according to milling time during surface-treatment of the pure iron powder using a ball mill, and FIG. 4 is a graph showing apparent density and flow time according to milling time when ball-milling using a ball with a diameter of 3 mm at a weight ratio of ball to pure iron powder of 8:1.

As seen from Table 3 and FIG. 4, as milling time gradually increases flow time decreases and apparent density increases, but when milling time is approximately 5 hours or longer apparent density and flow time are insufficiently improved. Thus, the milling time is limited to 5 to 7 hours in an exemplary embodiment of the present invention.

Meanwhile, when the milling time is 5 hours or shorter, apparent density and flow time are unsatisfactory, and when the milling time is longer than 7 hours production costs are disadvantageously increased. Thus, milling time is preferably limited between 5 to 7 hours in an exemplary embodiment of the present invention.

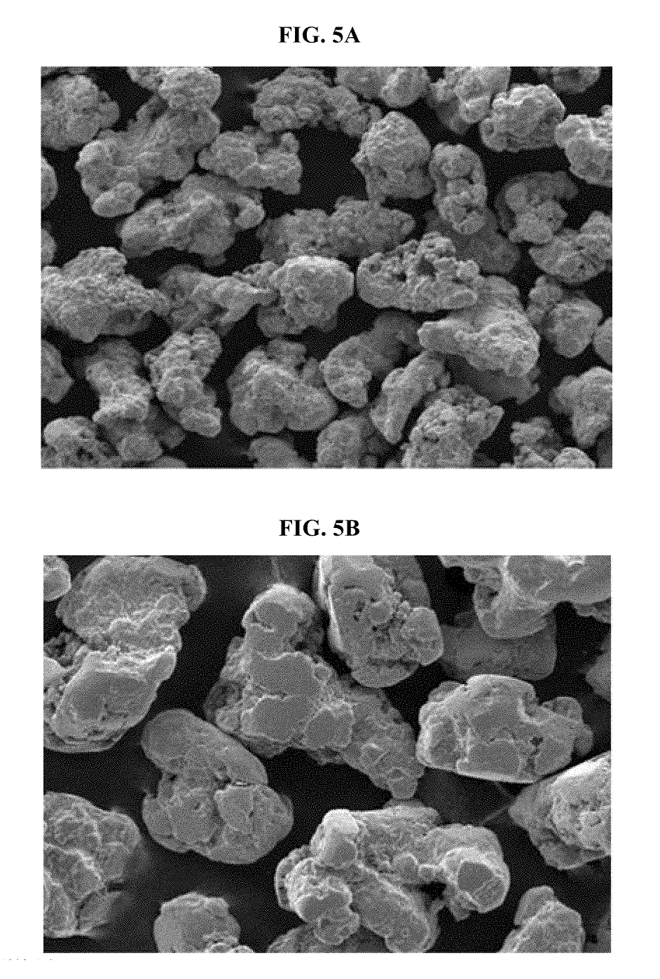

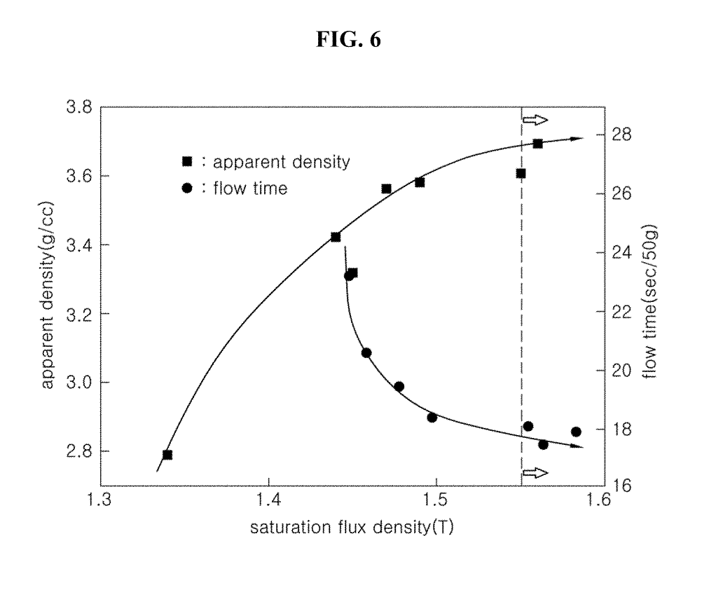

FIG. 5 depicts images showing general pure iron powder (A) and a pure iron powder (B) surface-treated according to an exemplary embodiment of the present invention. FIG. 6 is a graph showing saturation flux density after molding according to apparent density and flow time of a soft magnetic powder.

As seen from FIG. 5 and FIG. 6, the pure iron powder surface-treated according to an exemplary embodiment of the present invention has an increased apparent density and a decreased flow rate due to the spherical shape, as compared with general non-surface-treated pure iron powder.

In the present case, as apparent density increases molding density during molding increases. Apparent density is 3.6 g/cc or more and saturation flux density is 1.55 T or more. When the flow time is 18 seconds or shorter saturation flux density facilitating use as a soft magnetic part can be secured.

Accordingly, the pure iron powder surface-treated during milling according to an exemplary embodiment of the present invention preferably has an apparent density of 3.6 g/cc or more and a flow rate of 2.8 g/s or more.

After milling is completed, as described above, thermal treatment is conducted so that surface crystal grains of the pure iron powder surface-treated during milling can grow.

Thermal treatment according to an exemplary embodiment of the present invention is preferably carried out by reducing thermal treatment. The reason for the present is the following: during preparation of a pure iron powder in the preparation step, as the bath contacts high-pressure water or gas and rapidly cools, atomizing is conducted and the prepared pure iron powder is oxidized. Accordingly, while reducing the pure iron powder by thermal treatment under a hydrogen gas atmosphere or an inert gas atmosphere including nitrogen or argon, surface crystal grains are grown to secure excellent magnetic properties and the stress generated during milling is reduced.

TABLE 4

| | Use | Thermal | | Saturation | | | |
|---|---|---|---|---|---|---|---|
| | of | treatment | | flux | Core loss | | |
| | ball- | temperature | Density | density | (1.0 T, 400 Hz) | | |
| Items | mill | (° C.) | (g/cc) | (50 Hz) | P_{c} (W/kg) | Pₕ (W/kg) | P_{c} (W/kg) |
| Comparative | x | — | 7.0842 | 1.41 T | 78.74 | 70.42 | 8.32 |
| Example 1 | | | | | | | |
| Comparative | x | 500 | 7.0285 | 1.40 T | 82.64 | 66.95 | 15.70 |
| Example 2 | | | | | | | |
| Comparative | ∘ | — | 7.4210 | 1.53 T | 59.94 | 56.09 | 3.86 |
| Example 3 | | | | | | | |
| Comparative | ∘ | 450 | 7.4205 | 1.56 T | 46.25 | 42.61 | 3.63 |
| Example 4 | | | | | | | |
| Example 1 | ∘ | 480 | 7.3978 | 1.55 T | 42.83 | 39.01 | 3.82 |
| Example 2 | ∘ | 500 | 7.3946 | 1.55 T | 40.00 | 36.25 | 3.74 |
| Example 3 | ∘ | 530 | 7.4120 | 1.56 T | 41.70 | 34.14 | 7.56 |
| Comparative | ∘ | 550 | 7.3955 | 1.57 T | 55.14 | 32.89 | 22.25 |
| Example 5 | | | | | | | |

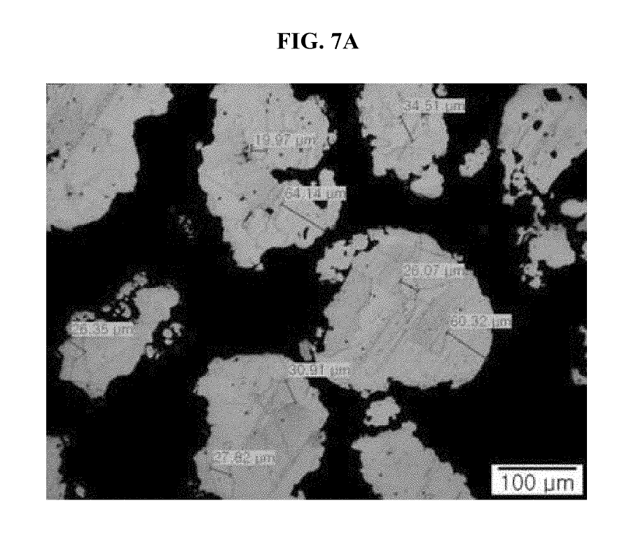

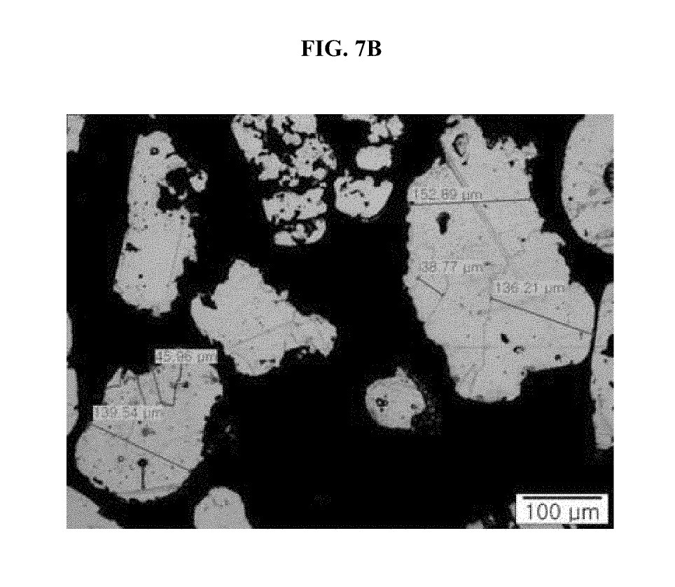

Table 4 shows density, saturation flux density and core loss measured in various Examples and Comparative Examples according to an exemplary embodiment of the present invention. FIG. 7 is an image depicting crystal grain sizes of general pure iron powder (A) and soft magnetic powder (B) prepared according to an exemplary embodiment of the present invention.

In the present case, the ball milling is carried out at a weight ratio of a ball, with a diameter of 3 mm, to pure iron powder of 8 for 6 hours.

Comparative Example 1 is a pure iron powder which has undergone neither milling nor thermal treatment, Comparative Example 2 is a pure iron powder which has undergone only thermal treatment without ball milling, Comparative Example 3 is a pure iron powder which has not undergone thermal treatment after ball milling, and Examples 1 to 3 and Comparative Examples 4 and 5 are pure iron powders obtained at different thermal treatment temperatures after ball milling.

As seen from Table 4, when milling is conducted, the powder becomes spherical in shape, and density and saturation flux density are improved and core loss is also reduced.

In particular, when only the thermal treatment is conducted without milling, density and saturation flux density are maintained to be equivalent to the pure iron powder, but core loss rapidly increases. On the other hand, when thermal treatment is conducted after milling, internal stress generated during milling is decreased, hysteresis loss (Pₕ) is reduced, core loss is lowered and magnetic properties are thus improved.

More preferably, the thermal treatment according to an exemplary embodiment of the present invention is preferably carried out under an inert atmosphere at a temperature of 480° C. to 530° C. because when thermal treatment is conducted at a temperature lower than 480° C. eddy current (Pₑ) loss is similar but hysteresis loss (Pₕ) is high and total core loss (P_{c}) thus increases. When the thermal treatment is conducted at a temperature higher than 530° C. hysteresis loss (Pₕ) is reduced but an insulation layer is broken due to the high temperature, eddy current (Pₑ) loss rapidly increases and core loss (P_{c}) exceeds 4.5 W/kg. Thus, the thermal treatment is preferably limited to the range defined above.

In addition, as shown in FIG. 7, when thermal treatment is conducted, as surface crystal grains of the soft magnetic powder grow soft magnetic properties are further improved, as compared to general pure iron powders which have not undergone thermal treatment.

As is apparent from the above description, the present invention has the effects of reducing apparent density and flow time through the sphericalization of the soft magnetic powder, and enhancing moldability, saturation flux density, and lowering core loss.

In addition, the present invention has the effects of preparing a cheap soft magnetic powder with improved soft magnetic properties by growing surface crystal grains of a soft magnetic powder made of pure iron.

For convenience in explanation and accurate definition in the appended claims, the terms “upper”, “lower”, “internal”, “outer”, “up”, “down”, “upwards”, “downwards”, “front”, “rear”, “back”, “inside”, “outside”, “inwardly”, “outwardly”, “internal”, “external”, “forwards” and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of producing a soft magnetic powder comprising:
spraying gas or water into a pure iron bath to prepare a pure iron powder;
surface-treating the pure iron powder by milling to increase surface stress of the pure iron powder and make the pure iron powder spherical; and
subjecting the surface-treated pure iron powder to reducing thermal treatment to grow surface crystal grains of the pure iron powder and to prepare the soft magnetic powder.

2. The method according to claim 1, wherein the milling is carried out by ball-milling using a ball with a diameter of 2.5 to 3.5 mm.

3. The method according to claim 2, wherein the milling is carried out by milling in a weight ratio of the ball to the pure iron powder of 7:1 to 10:1 for 5 to 7 hours for surface-treatment.

4. The method according to claim 3, wherein, during the milling, the surface-treated pure iron powder has an apparent density of 3.6 g/cc or more and a flow rate of 2.8 g/s or more.

5. The method according to claim 3, wherein, during the milling, the surface-treated pure iron powder has an apparent density of 3.6 g/cc or more and a flow time of 18 s/50 g or less.

6. The method according to claim 1, wherein the thermal treatment is carried out under an inert atmosphere at a temperature of 480 to 530° C.

7. The method according to claim 1, wherein the soft magnetic powder has a saturation flux density of 1.55 T or more and a core loss of 45 W/kg or less under conditions of 400 Hz and 1.0 T.
